(19) United States
(12) Patent Application Publication
(10) Pub. No.: US 2007/0009573 A1
(43) Pub. Date: Jan. 11, 2007

(54) Method of forming immediate release dosage form

(75) Inventor: Pankaj S. Chudgar, Commack, NY (US)

Correspondence Address: LAW OFFICES OF ARTHUR E. JACKSON, P.O. BOX 88, HOPEWELL, NJ, 08525, US

(73) Assignee: L N K International

(21) Appl. No.: 11/176,825

(22) Filed: Jul. 7, 2005

(51) Int. Cl. B29C 45/00

(52) U.S. Cl. 424/426; 264/238

(57) ABSTRACT

Provided among other things is a method of making an elongate dosage form comprising: providing an elongate core with two ends and a waist, the core comprising a bioactive agent and a release agent that swells on contact with water; coating the core with a polymer coating; enrobing the ends of the core with two preformed gel capsule parts, leaving the waist coated only with the polymer coating; shrink fitting the gel capsule parts to the core; and forming a pattern of holes in the polymer coating of the waist, with the pattern, size and density of the holes selected to allow water ingress to the core and to help burst the polymer coating on swelling of the core due to water ingress.

The present invention relates to a method of making an immediate release dosage form.

It has long been known that to provide immediate release one can use an appropriate thin film coating with appropriate release agents in the coated core, such as sodium starch glycolate, to cause the dosage form to burst when immersed in water. See, for example, U.S. Pat. No. 4,897,270. Such immediate release can be facilitated by weakening the film coating, such as by incorporating swellable particles in the coating so as to form holes when immersed in water. See U.S. Pat. No. 6,531,152. Also, using direct pores through a coating to a core containing appropriate excipients is a known tool for speeding the release of a pharmaceutical agent. See WO 02/11702 at p. 2.

Thus, one immediate release formulation for acetaminophen that is on the market uses these release tools in a dosage form that contains sodium starch glycolate as a release agent. The caplet-shaped core is initially coated with a polymer composition believed to consist primarily of hydroxypropyl methylcellulose (i.e., hypromellose). The two ends, but not an intermediate waist area, are dip coated with a gelatin composition. Then, on one side of the caplet shape, two different sized holes are laser drilled through the hydroxypropyl methylcellulose coating (as taught in US 2004/0253312 at ¶0141 and FIG. 6). The larger holes serve to expedite influx of water, and the smaller serve as perforations.

It has now been discovered that such an immediate release dosage form can be efficiently made with an enrobing process. Enrobing processes have been known for encasing gelcaps, with the enrobed capsule halves overlapping or abutting to provide closure. It has now been discovered that such enrobing can provide a stable dosage form with no overlap and a hydroxypropyl cellulose and hydroxypropyl methylcellulose coated waist area that is left without gel coating.

Also, it has now been discovered that the use of perforation-sized holes, if in an appropriate number and distribution, is effective to provide water influx to rapidly burst open the dosage form. Such perforations are effective to sufficiently mask the taste of the active and its excipients during oral administration.

### SUMMARY OF THE INVENTION

Provided among other things is a method of making an elongate dosage form comprising: providing an elongate core with two ends and a waist, the core comprising a bioactive agent and a release agent that swells on contact with water; coating the core with a polymer coating; enrobing the ends of the core with two pre-formed gel capsule parts, leaving the waist coated only with the polymer coating; shrink fitting the gel capsule parts to the core; and forming a pattern of holes in the polymer coating of the waist, with the pattern, size and density of the holes selected to allow water ingress to the core and to help burst the polymer coating on swelling of the core due to water ingress.

In another embodiment, provided is an elongate dosage form comprising: an elongate core with two ends and a waist, the core comprising a bioactive agent and a release agent that swells on contact with water; a polymer coating of the core; at the two ends but not at the waist, a gel coating over the polymer coating; and a pattern of holes in the polymer coating of the waist, all holes 0.8 mm or less in diameter, with the pattern, size and density of the holes selected to allow water ingress to the core and to help burst the polymer coating on swelling of the core due to water ingress.

### BRIEF DESCRIPTION OF THE DRAWINGS

FIG. 1 shows a top view of a dosage form of the invention.

FIG. 2 shows a cut-away view of a dosage form of the invention.

FIG. 3 shows a dosage form made by a method outside the invention (indicating pattern of holes to approximate scale).

### DETAILED DESCRIPTION OF THE INVENTION

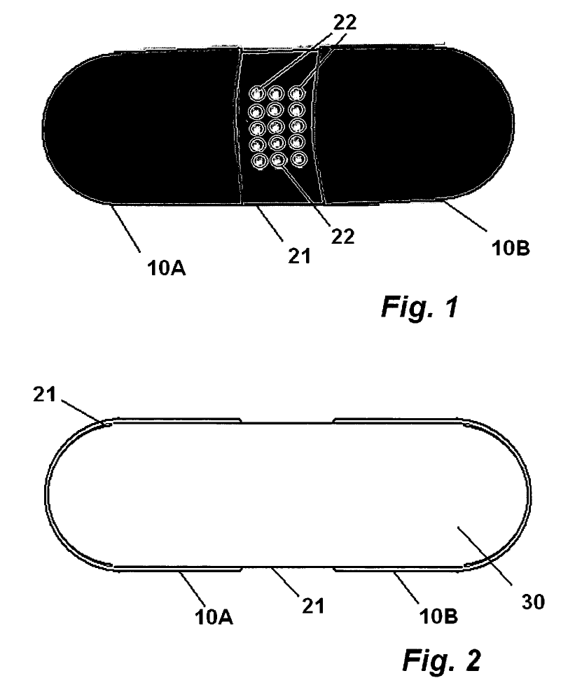

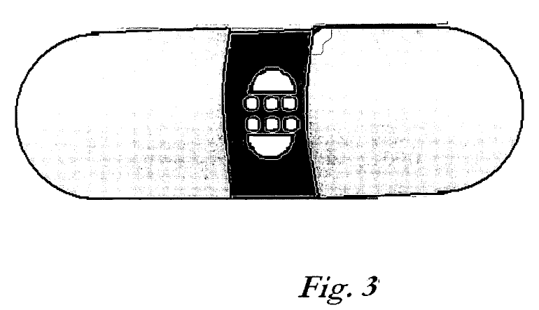

A device of the invention is shown in FIG. 1. The ends of the dosage form are enrobed with gel capsule parts 10A and 10B. The waist area is coated with coating 21, as shown in the cutaway view of FIG. 2. The dosage form can be, for example, about 14 mm in length. Openings 22 allow water to enter the core 30, causing swelling and rupture facilitated by the openings, which serve as perforations. While not shown in the figure, among other shapes, the dosage form core can have flattened sides running along the length on opposite sides of the elongated shape. This shape will typically be translated, at least in part, to the enrobed capsule parts. In the exemplified dosage form, thickness of the core is 0.235 to 0.241 inches.

The openings 22 can be, for example, about 0.8 mm or less in diameter, or from about 0.2 to about 0.8 mm in diameter, or from about 0.3 to about 0.6 mm, or from about 0.35 to about 0.55 mm, or from about 0.4 to about 0.5 mm. For example, the openings can be about 0.45 mm in diameter. The openings can be through to the core, or transit 80% or more of the thickness of coating 21 while providing the water influx and perforation function. For example, the openings can transit 85% or more, or 90% or more, or 95% or more, or 97% or more, or 98% or more, or 99% or more of the thickness of coating 21.

The density of openings can be, for example, about 1.5 mm⁻² or higher, or about 1.6 mm⁻² or higher, or about 1.7 mm⁻² or higher, or about 1.8 mm⁻² or higher. The density of openings can be, for example, about 2.0 mm⁻² or lower, or about 1.9 mm⁻² or lower. For example, the density can be from about 1.6 mm⁻² to about 2.0 mm⁻². The openings can be, for example, in 2 to 3 rows aligned parallel to the ends of the gel capsule parts, and can number, for example, 10 or more, or 12 or more, or 13 or more, or 14 or more, or 15 or more. The openings can number, for example, 20 or less, or 19 or less, or 18 or less, or 17 or less, or 16 or less. For example, the openings can number 12 to 18.

In certain embodiments, the separation of the gel capsule parts defining the waist area is about 2.0 mm to about 5 mm, or about 2.5 mm to about 4.5 mm, or about 2.5 mm to about 4.0 mm, or about 2.5 mm to about 3.5 mm, or about 2.7 mm to about 3.3 mm, or about 2.8 mm to about 3.2 mm.

The core 10 contains a swelling providing amount of a release agent such as sodium starch glycolate, croscarmellose sodium, corn starch, or the like. For example, the release agent can provide about 2% by weight or more of the core, or 2.2% or more, or 2.4% or more, or 2.6% or more, or 2.8% or more, or 3.0% or more. For example, the release agent can provide about 5% by weight or less of the core, or 4.8% or less, or 4.6% or less, or 4.4 or less, or 4.2% or less, or 4.0% or less, or 3.8% or less, or 3.5% or less. In addition to one or more bioactive agents, the core may contain additional excipients such as binding agents, disintegrants, flow aids, and the like, as is known in the art.

The bioactive agent(s) are generally those whose solubility, with or without the help of solubilizing agents, allows for immediate release. Bioactive agents may include, for example, acetaminophen, ibuprofen, acetyl salicylic acid, or the like. Where appropriate, the bioactive agent can comprise a substantial portion of the core, such as about 80% or more by weight, or 85% or more, or 86% or more, or 87% or more, or 88% or more, or 89% or more, or 90% or more.

The coating 21 is applied by any method known in the art. One useful method is film coating. The coating composition is selected to provide, for example, an elegant color, taste mask, and allow for rupture according to the invention. One coating composition that can be used is sold by Colorcon as Opadry 20F, and is made up of hydroxypropyl cellulose (HPC), hydroxypropyl methylcellulose (HPMC), titanium dioxide, polyethylene glycol and dye(s). The coating can be applied to a thickness of, for example, 0.2 mm or less, or 0.18 mm or less, or 0.16 mm or less, or 0.14 mm or less. The thickness can be, for example, 0.1 mm or more. Additional suitable polymer compositions can be identified by those of skill in light of these teachings.

The gel capsule parts can be enrobed on the cores by a shrinkage process, such as that managed by the Zanasi 70C [from IMA, Bologna, Italy]. The capsule parts are applied to the caplet core ends at a controlled temperature and humidity. With drying and cooling, the capsule parts shrink to tightly conform to and fit the core ends. Suitable gel capsule parts include, for example, the Press-Fit® gelcaps available from Capsugel (Greenwood, S.C.). The gel capsule parts are selected to melt at or near 37° C.

It should be noted that “shrink fitted” capsule parts can be visually distinguished from parts formed from a liquid phase. Hence, the use of this terminology does not imply a process step unless the context is the description of a process step.

Holes are formed in the polymer coating at the waist. The forming can be by molding or impressing during the coating process. Or, the holes can be drilled such as by laser or mechanical drilling. Or, the holes can be formed by any other appropriate method.

The following examples further illustrate the present invention, but of course, should not be construed as in any way limiting its scope.

### EXAMPLE 1

A 555 mg of a drum to hopper material (supplied by Mallinckrodt, St. Louis, Mo.) that is 90% by weight acetaminophen is compressed to cores with a thickness of 0.235-0.241 inches and a hardness of 4-15 kp. The components of the drum to hopper material are acetaminophen, pregelatinized starch, croscarmellose sodium, povidone and stearic acid. The cores are then coated with Opadry, such as a mixture of Opadry Gray 20F17695 and Opadry Clear 20F19223 to a weight gain of 3% by wt. The cores are then enrobed with two Press-Fit® gelcaps, leaving a middle section coated only with Opadry film between the two gelcaps. The film in the middle section is then laser drilled to provide three rows of five openings in the film as illustrated in FIG. 1A.

### DEFINITIONS

Bioactive Agent

A bioactive agent is a substance such as a chemical that can act on a cell, virus, tissue, organ or organism, including but not limited to drugs (i.e., pharmaceuticals) to create a change in the functioning of the cell, virus, organ or organism to achieve a pharmaceutical or therapeutic effect.

Publications and references, including but not limited to patents and patent applications, cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

What is claimed:

1. A method of making an elongate dosage form comprising:
providing an elongate core with two ends and a waist, the core comprising a bioactive agent and a release agent that swells on contact with water;
coating the core with a polymer coating;
enrobing the ends of the core with two pre-formed gel capsule parts, leaving the waist coated only with the polymer coating;
shrink fitting the gel capsule parts to the core; and
forming a pattern of holes in the polymer coating of the waist, with the pattern, size and density of the holes selected to allow water ingress to the core and to help burst the polymer coating on swelling of the core due to water ingress.

2. The method of making a dosage form of claim 1, wherein the width of the formed holes is 0.8 mm or less in diameter

3. The method of making a dosage form of claim 1, wherein the openings formed are from 0.2 to 0.8 mm in diameter.

4. The method of making a dosage form of claim 1, wherein the openings formed transit 80% or more of the thickness of coating.

5. The method of making a dosage form of claim 1, wherein the density of the formed openings is 1.5 mm⁻² or higher.

6. The method of making a dosage form of claim 1, wherein, after shrink fitting, the gel capsule parts are separated by a distance of 2.0 mm to 5 mm.

7. The method of making a dosage form of claim 1, wherein the holes are laser drilled.

8. An elongate dosage form comprising:
an elongate core with two ends and a waist, the core comprising a bioactive agent and a release agent that swells on contact with water;
a polymer coating of the core;
at the two ends but not at the waist, a gel coating over the polymer coating; and
a pattern of holes in the polymer coating of the waist, all holes 0.8 mm or less in diameter, with the pattern, size and density of the holes selected to allow water ingress to the core and to help burst the polymer coating on swelling of the core due to water ingress.

9. The dosage form of claim 8, wherein the openings are from 0.2 to 0.8 mm in diameter.

10. The dosage form of claim 9, wherein the openings number 12 to 20.

11. The dosage form of claim 8, wherein the openings number 12 to 20.

12. The dosage form of claim 8, wherein the gel coating is shrink fitted to the polymer coated core.

13. The dosage form of claim 8, wherein the gel capsule parts are separated by a distance of 2.0 mm to 5 mm.
